(19) United States
(12) Patent Application Publication
(10) Pub. No.: US 2006/0265184 A1
(43) Pub. Date: Nov. 23, 2006

(54) Method and system for analyzing data for low density sample space

(76) Inventor: Murray Tondow, Santa Rosa, CA (US)

Correspondence Address: HAVERSTOCK & OWENS LLP, 162 NORTH WOLFE ROAD, SUNNYVALE, CA, 94086, US

(21) Appl. No.: 11/416,580

(22) Filed: May 2, 2006

Related U.S. Application Data
(60) Provisional application No. 60/678,129, filed on May 4, 2005.

(51) Int. Cl. G06F 19/00

(52) U.S. Cl. 702/181

(57) ABSTRACT

The present invention is directed to a method of and a system for analyzing test scores obtained from a sample space based on a plurality of scales, each scale including at least one test score. A preference is known regarding each member of the sample space. The method includes generating a filter including selecting a first group of scales from among the plurality of scales, which accommodates the preference, and comparing a new subject against the first group of scales for conformance to the preference. The filter can be updated, modified, adjusted, and/or refined. A system for analyzing test scores includes a database for storing test scores and a plurality of scales, a computer coupled to the database, the computer configured for generating a filter including selecting a first group of scales from among the plurality of scales which accommodates a preference known regarding each member of a sample space and for comparing a new subject against the first group of scales for conformance to the preference, and a terminal coupled to the computer, the terminal having a user interface for inputting a user-defined evaluation of the first group of scales.

### RELATED APPLICATIONS

This Patent Application claims priority under 35 U.S.C. § 119(e) of the co-pending U.S. Provisional Patent Application Ser. No. 60/678,129, filed May 4, 2005, and entitled “METHOD OF ANALYSING DATA FOR LOW DENSITY SAMPLE SPACE.” The Provisional Patent Application Ser. No. 60/678,129, filed May 4, 2005, and entitled “METHOD OF ANALYSING DATA FOR LOW DENSITY SAMPLE SPACE” is also hereby incorporated by reference in its entirety.

### FIELD OF THE INVENTION

The present invention relates to the field of data analysis. More specifically, the present invention is directed to a method of and a system for analyzing data for a low density sample space.

### BACKGROUND OF THE INVENTION

Psychological testing can provide assessments of subjects. Specifically, psychological tests are helpful in assessing personal, social, and behavioral issues concerning the subjects. Psychological tests can also be used to predict behavioral patterns of subjects given certain situations and parameters. For instance, some psychological tests are used to predict how subjects will react under intense stress and pressure.

Statistical analysis of the results can be used to support the predictions. Generally, a large data pool is necessary to provide meaningful results. For some situations, different characteristics are unexpectedly desired for persons. For example, a police officer for duty in a violent crime ridden major city might need an ability to cope with greater stress from danger than a police officer from a peaceful rural town. However, conventional statistical analyses in such situations are ineffective because the sample size is small.

One psychological test-used to predict subject behavior is called the Minnesota Multiphasic Personality Inventory (MMPI). Typically, the MMPI includes a series of questions to test certain personality characteristics or traits. Test scores of the MMPI are derived from the subject's answers to the questions. Then, typically, a psychologist reviews the MMPI test scores, as part of a psychological evaluation of the subject. However, problems may arise in evaluating psychological testing for a sample space, where further refinement of evaluated scales and scores may be necessary to shed light on previously overlooked aspects of the evaluation. Such problems can be exacerbated when the sample space includes a relatively small number of subjects.

### SUMMARY OF THE INVENTION

The present invention provides a method of and a system for analyzing test scores as well as other relevant data obtained for a sample space based on a plurality of scales. The sample space can comprise a low density sample space. Preferably, the test scores are based on psychological testing, such as the MMPI, where the testing is conducted on at least a first subject group and a second subject group of the sample space. There are different formats of the MMPI, and different scoring systems for the MMPI-1 and MMPI-2. Preferably, this invention can be applied in conjunction with the MMPI-2. However, this invention is not limited solely to the MMPI; the invention encompasses all tests, evaluations, appraisals, and any other systems that measure or evaluate at least one predictor variable, aspect or trait of a sample space.

A first aspect of the invention is directed to a method of analyzing test scores obtained from a sample space based on a plurality of scales for each member of the sample space. Each scale includes at least one test score. A preference is known regarding each member. The method includes the steps of generating a filter including selecting a first group of scales from among the plurality of scales which accommodates the preference and comparing a new subject against the first group of scales for conformance to the preference.

A second aspect of the invention is directed to a method of applying statistical analysis to behavioral test scores. The method comprises at least five steps. The method includes the step of assigning behavioral test scores obtained from a sample space based on a plurality of scales for each member of the sample space. A preference is known regarding each member. The sample space includes at least a first subject group and a second subject group. Each scale includes at least one test score. The method also includes the step of selecting a first group of scales from among a plurality of scales. Further, the method includes the step of evaluating the first group of scales, based upon a user input. The method also includes the step of determining a set of statistics for the first subject group and the second subject group. Finally, the method comprises the step of comparing the first subject group and the second subject group based upon the first group of scales for conformance to the preference. One of the first and second subject groups has at least one new subject.

A third aspect of the invention is directed to a method of analyzing test scores obtained from a sample space based on a plurality of scales for each member of the sample space. Each scale includes at least one test score. A first preference is known regarding each member. The method includes at least four steps. A filter is generated including selecting a first group of scales from among the plurality of scales which accommodates the first preference. Test scores obtained from a new subject are compared against the first group of scales for conformance to the first preference. A second preference is determined, where the second preference is known regarding each member of the sample space and the new subject, in the event that the test scores of the new subject do not conform to the first preference. Further, the filter is updated, in the event that the test scores of the new subject do not conform to the first preference. The updating includes selecting a second group of scales from among the plurality of scales which accommodates the second preference.

A fourth aspect of the invention is directed to a method of analyzing test scores obtained from a sample space based on a plurality of scales for each member of the sample space. Each scale includes at least one test score. A first preference is known regarding each member. The method includes at least four steps. A filter is generated including selecting a first group of scales from among the plurality of scales which accommodates the first preference. At least one member is removed from the first sample space, thereby producing a second sample space. A second preference is determined, where the second preference is known regarding each member of the second sample space. Further, the filter is updated. The updating includes selecting a second group of scales from among the plurality of scales which accommodates the second preference.

A fifth aspect of the invention is directed to a computer readable medium having a program stored thereon. The program has a set of instructions for generating a filter including a first group of scales from among a plurality of scales which accommodates a preference known regarding each member of a sample space. The program also has a set of instructions for comparing a new subject against the first group of scales for conformance to the preference. The program is for analyzing test scores obtained from the sample space based on the plurality of scales, each scale including at least one test score.

A sixth aspect of the invention is directed to a system for analyzing test scores obtained from a sample space based on a plurality of scales for each member of the sample space wherein a preference is known regarding each member. The system includes a database for storing the test scores and the plurality of scales. Each scale comprises at least one test score. A computer is operatively coupled to the database. The computer is configured for generating a filter including selecting a first group of scales from among the plurality of scales which accommodates the preference. The computer is also configured for comparing a new subject against the first group of scales for conformance to the preference. A terminal is operatively coupled to the computer. The terminal has a user interface, wherein the user interface is configured for receiving a user input evaluation of the first group of scales.

### BRIEF DESCRIPTION OF THE DRAWINGS

FIG. 1 illustrates a method of analyzing data obtained from a sample space.

FIGS. 2A and 2B illustrate the method of FIG. 1 in greater detail, with further optional steps, in accordance with some embodiments of the present invention.

FIG. 3 illustrates a method of analyzing data of a sample space, in accordance with a preferred embodiment of the present invention.

FIG. 4 illustrates the entity relationship diagram of a database used in a system for analyzing test scores obtained from a sample space, in accordance with the preferred embodiment of the present invention.

FIGS. 5A and 5B illustrate tables for data constants, score types, and scales for the database of FIG. 4, in accordance with the preferred embodiment of the present invention.

FIG. 6 illustrates an example of a listing for scale/score observations for a sample space having a first subject group and a second subject group, in accordance with the preferred embodiment of the present invention.

FIG. 7 illustrates the P4 variables for a subject in a psychological study, in accordance with the preferred embodiment of the present invention.

FIG. 8 illustrates a computer readable medium having a program for analyzing test scores obtained from a sample space, in accordance with the preferred embodiment of the present invention.

FIG. 9 illustrates a system for analyzing test scores obtained from a sample space, in accordance with the preferred embodiment of the present invention.

FIG. 10 illustrates a method of analyzing data of a sample space, which includes an updating of a filter, in accordance with the preferred embodiment of the present invention.

FIG. 11 illustrates a method of analyzing data of a sample space, which includes an updating of a filter, in accordance with a further embodiment of the present invention.

### DETAILED DESCRIPTION OF A PREFERRED EMBODIMENT

The present invention provides a method of and a system for analyzing data obtained from a sample space. Certain terms and phrases are used in describing the present invention. As used throughout, the term “predictor” indicates that a variable is part of the filter. Predictor variables include, but are not limited to, scales, test scores, traits, characteristics, and any element(s) such as sex, age, race, height, and the like, to predict an outcome that are included in the filter. The term “filter” as used throughout refers to one or more variables identified by the invention as predictor variables being sought by the method or system. The term “preference” as used throughout refers to a common trait or traits shared by a group, and does not represent a value judgment as to whether the preference is positive or negative. Further, the term “data” as used throughout is not limited to test scores alone. Data can include any factual information obtained from the sample space, including but not limited to quantifiable information concerning characteristics, traits, abnormalities, behavioral norms, measurements, statistics, and projected outcomes of the sample space. “Statistics” as used throughout includes any type of data or information that can be measured, derived, calculated, quantified, or otherwise obtained from the data of the sample space.

The invention is advantageous over conventional methods and systems in several ways. For instance, conventional data analysis provides a view of an issue only from an aggregate proposition. That is, conventional data analysis provides predictive results that apply to an entire aggregate group of subjects, rather than to an individual subject. In contrast, the invention provides results that can view an issue from a general proposition. In other words, the invention applies a Bayesian-like statistical analysis technique to existing behavioral testing data retrospectively, and as a result, the invention in part generates a filter that provides an improved behavioral prediction over conventional methods. The filter can encompass a preference known about each member of the sample space; that is, the filter can include a group of scales or scores which reflect the preference of particular predictor variables that are shared by each member of the sample space. A filter can include but is not limited to a profile, a template, a formula, a predictor, a set of one or more variables, and an algorithm.

In the area of psychological testing, the filter represents a functional set of predictor variables for a candidate. A new subject passes the filter if they have or possess all the variables and scores identified in the filter. A new subject fails the filter if they do not have or possess at least one or more of the variables and/or scores identified in the filter. With the invention, it can be determined on an individual basis whether a new subject has the predictor variables identified in the filter, where the filter was generated based on a subject group. Typically, the filter is generated based on a control group, and the new subject (included in a study group) is compared against the control group via the filter.

Another advantage of the invention over conventional methods and systems of data analysis is that the invention can be applied to a low density sample space. The invention can be used in any setting or situation where data is obtained from a sample space. The data preferably includes test scores or any other type of measurement of at least one characteristic from the sample space. The sample space is preferably a collection of subject groups, each subject group having one or more subjects. Although the sample space can be of any size, the sample space preferably includes a low density sample space having no more than fifty subjects in total. In contrast to the invention, conventional methods and systems fail to provide adequate nor practical results based on data collection from a low density sample space. Furthermore, the invention allows for updating of the filter such that the filter can be refined, adjusted and/or modified in a timely manner, without difficulty. In other words, if a new subject is added to the sample space and the new subject provides anomalies, the filter can be tailored or updated-on an ongoing basis to encompass the anomalies.

If the filter is not tailored and/or updated on an ongoing basis, the filter is effective and/or remains accurate for only a finite time. Preferably, if the filter is not updated, the filter is effective for up to four years, based on feedback from studies thus far. However, one skilled in the art will recognize that a filter that is not updated can be effective for less or more than four years, depending on the application at hand. A method of updating a filter is disclosed in greater detail later herein.

Further, the invention can allow for filters to be generated for a specific locality, field, culture, community, and even to a particular employer or company. The invention allows for input of behavior test data that can be subjectively selected by a customer or a user. For example, if the invention is being applied to select an ideal job candidate for a police department, a police chief can subjectively determine that he has ten officers (Officers 1-10) who reflect the performance he is seeking in an ideal police officer. In other words, the police chief can submit the data test scores of Officers 1-10 for input to the invention, such that the invention can generate a filter based on those test scores where a preference is known regarding each test subject. The police chief can also subjectively determine that he has 2 officers (Officers 11 and 12) who have traits that are not desirable and that information can also be inputted to the invention. Then, the invention can provide a filter that is tailored to the needs of a specific locality, field, culture, community, and even to a particular employer or company. A filter for a police officer position in San Francisco is likely to be dissimilar to a filter for a police officer position in Los Angeles.

Preferably, the invention allows for input of scored data or test scores. The invention is applicable to data or test scores obtained by psychological assessments and tests, such as the Minnesota Multiphasic Personality Inventory (hereinafter “MMPI”). For instance, with the MMPI, test scores are obtained from subjects based on their answers to a series of true/false questions. The true/false questions are then tabulated, and subjects' test scores are mapped or assigned to a plurality of scales. Based on the test scores, the scales, derived scores, and factors of the MMPI can provide further information regarding at least one characteristic or trait of the sample space.

The invention, however, is not limited solely to psychological tests; rather, it will be appreciated by those skilled in the art that the present invention can be used in a variety of areas and disciplines, including but not limited to psychiatric evaluations, personality tests, performance evaluations or tests, physical examination tests, endurance tests, appraisals, competitions of all sorts (including but not limited to beauty competitions, talent competitions, and any combination thereof), intelligence tests, coordination tests, health tests, product evaluation compatibility tests on subjects, fitness tests, job placement evaluations, drug testing, and the like.

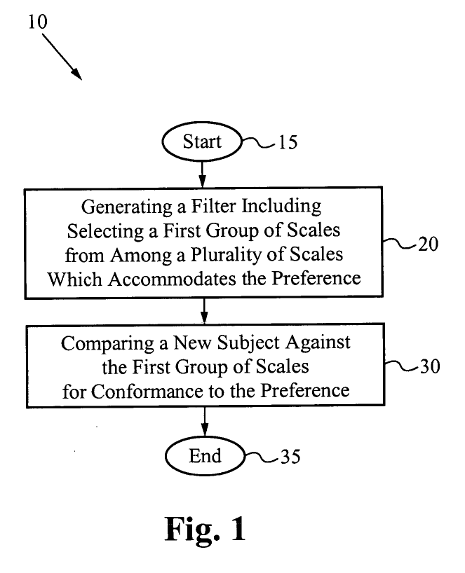

FIG. 1 is a flowchart of a method 10 of analyzing data, in accordance with a preferred embodiment of the present invention. The data is obtained from a sample space, and the data is preferably based on a plurality of scales for each member of the sample space. Preferably the data includes test scores, and each scale includes at least one test score. A preference is known regarding each member.

As shown in FIG. 1, the method 10 begins with a start step 15. The start step 15 is followed by a step 20 for generating a filter including selecting a first group of scales from among the plurality of scales which accommodates a preference known regarding each member of the sample space. Then, at a step 30, a new subject is compared against the first group of scales for conformance to the preference. Finally, the method 10 ends at an end step 35. It will be apparent to those skilled in the art that one or more step(s) can be added and/or deleted from the method 10, without departing from the spirit and scope of the present invention.

The selecting in the generating step 20 is preferably automatic given that an automated device, machine or computerized system can choose the first group of scales from among the plurality of scales. Thus, in some embodiments, the generating step 20 can include further steps of computerized ranking of the plurality of scales based on at least one criterion and assigning, from among the plurality of scales, the first group of scales, based on their associated rankings. The criterion can be programmable, and it can be any standard or basis for the ranking. The generating step 20 is preceded by a step of calculating a test score, for each of the plurality of scales (not shown). For instance, with the MMPI, a t-test result can be calculated for each of the plurality of scales prior to the generating step 20.

The plurality of scales are preferably ranked by a computer in numerical order based on the criterion. For example, if each scale includes only one t-test result, the generating step 20 includes a computerized ranking of the plurality of scales based on their t-test results in descending order. In this example, the criterion is the numerical value of the t-test result for each scale. Once the computerized ranking is completed, then a first group of scales are assigned from the plurality of scales, based on their associated rankings. For example, if forty scales are ranked in descending numerical order based on the criterion of t-test results, then the first group of scales can be assigned, where the first group of scales are those scales having the highest t-test results. It will be apparent to those skilled in the art that the number of scales included in the first group of scales can be any number, and further the number can be preset and/or programmable at any time. In the preferred embodiment, the generating step 20 can include further steps of computerized ranking of the plurality of scales based on their associated t-test results and determining the first group of scales from among the plurality of scales, based on their associated t-test result rankings. Preferably, the first group of scales are highlighted, marked or displayed in some distinguishing manner to indicate to the user that the first group of scales has been determined in the generating step 20.

The generating step 20 can also include evaluating the first group of scales based upon a user input. The generating step 20 can further include refining, or alternatively, modifying the first group of scales in some way. In other words, the first group of scales can be adjusted or tailored based on a user's needs or requirements. The user input used in the generating step 20 is preferably obtained via a user interface of a computer. However, it is well known in the art how user input can be entered or conveyed via a device or system.

Alternatively, the generating step 20 can include assigning a scale to the first group of scales. Thus, a scale that was not initially selected can be later assigned to the first group of scales based on a user input. Preferably, a scale is highlighted, marked, or displayed in some distinguishing manner by user input to represent that the scale is assigned to the first group of scales. Alternatively, the generating step 20 includes re-assigning a scale from the first group of scales to a second group of scales. Preferably, user input through a user interface of a computerized or automated system is used for a reassignment of a scale. The method 10 also allows for an optional step of tracking scales that are not included in the first group of scales (not shown). Alternatively, the method 10 allows an optional step of tracking scales that are re-assigned from the first group of scales to the second group of scales (not shown). That is, the method 10 optionally allows for a user to track those scales which “fall out” of the first group of scales, either through automatic selection by a computer or by user input.

Once the filter is generated at the step 20, at a step 30 a new subject is compared against the first group of scales for conformance to the preference. Statistics can be determined for the sample space at the step 30. A sample space includes a collection of subjects, where preferably the subjects are grouped in a plurality of subject groups. In some embodiments, the sample space includes at least a first subject group and a second subject group. Preferably, the first subject group includes a “study group” and includes at least the new subject. The second subject group can include a “control group,” or alternatively, a group called the “other group.” The comparing step 30 can include further steps of sampling the first subject group, thereby producing a plurality of sample sets, and performing statistical analysis on each of the plurality of sample sets. Sampling the first subject group is preferably randomized by any conventional random algorithm; however, it will be appreciated by those skilled in the art that the method 10 does not require random sampling. Further, if the first subject group has only one subject, then random sampling is not applicable.

For example, assume that the first subject group includes twenty subjects. During the comparing step 30, the first subject group is randomly sampled, such that one or more sample sets are produced. From the first subject group, a first sample set (Sample A) could include 20 percent of the first subject group, and a second sample set (Sample B) could include 80 percent of the first subject group. Thus, Sample A includes four subjects of the first subject group randomly selected, while Sample B includes sixteen subjects of the first subject group, randomly selected. It will be apparent to those skilled in the art that Sample A and Sample B are exemplary only. There can be one or more sample sets, and each sample set can include a same or different percentage of the first subject group ranging from 0 percent to 100 percent, based upon the application at hand.

The comparing step 30 can also include the steps of performing statistical analysis on the second subject group and then comparing the statistics of a sample set of the first subject group with the statistics of the second subject group. For example, if the first subject group is the “study group” and the second subject group is the “other group,” then the comparing step 30 allows for statistical analysis to be performed on the other group. Once the “other group” statistics are determined, then the comparing step 30 also can include performing statistical analysis of a sample set of the first subject group. Further, the comparing step 30 can include comparing the “other group” statistics against the statistics of a sample set (such as the sample set “Sample A” described in the previous example) of the “study group.” The statistics can preferably include the statistics of mean, variance, standard deviation, range, maximum, minimum, sum, sum of squares, and any combination thereof. However, this list of statistics is not meant to be exhaustive, but rather illustrative. The method 10 can also include a step of displaying statistics obtained from the step 30. Thus, one can review the statistics to determine if further statistical analysis and/or evaluation of the first group of scales is required.

As an example of a use of the method of FIG. 1 consider a program for hiring police officers. Consider that the captain of a small police force in a suburban setting needs to hire several officers. He has certain officers on his force that have desirable suburban performance characteristics that he wants in his officers and other officers with characteristics that he does not want. The officers on his force provide data such as taking the MMPI. The officers that have desirable suburban characteristics form the suburban control group and their data are used to select the scales. The chief of a major urban police force also needs to hire several officers. She has certain officers on her force that have desirable urban characteristics she wants in her officers and other officers with characteristics that she does not want. The officers on her force also provide data. The officers that have desirable urban characteristics form the urban control group and their data are used to select the scales. The suburban characteristics and the urban characteristics likely have overlapping scales and also non-overlapping scales.

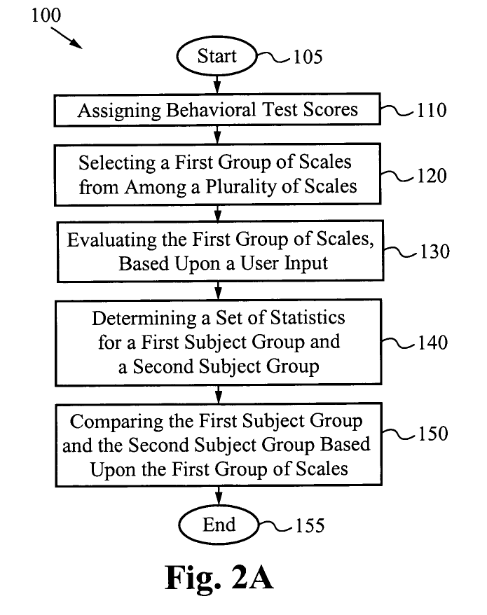

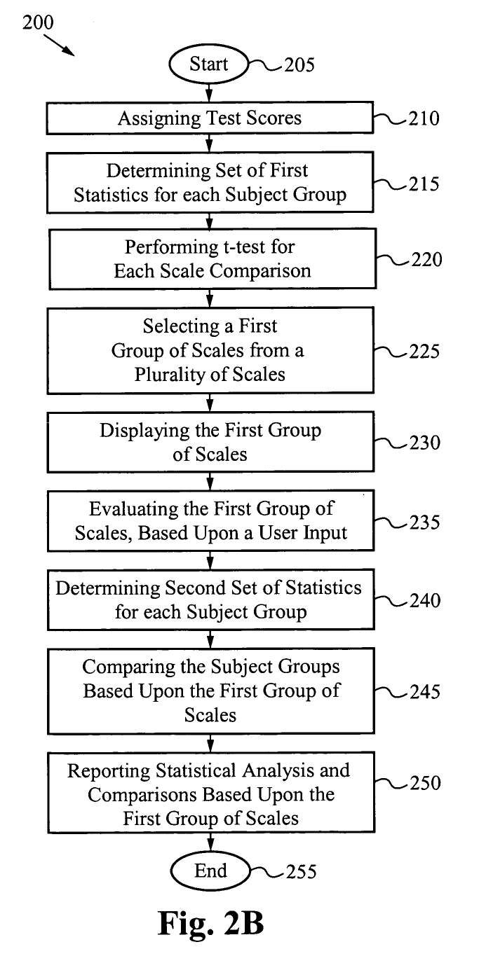

A better understanding of FIG. 1 can be obtained by viewing it in conjunction with FIGS. 2A and 2B. FIG. 2A is a flow chart of a method 100 for analyzing test scores obtained from a sample space based on a plurality of scales. It will be apparent to those skilled in the art that one or more step(s) can be added and/or deleted from the method 100, without departing from the spirit and scope of the present invention.

As shown in FIG. 2A, the method 100 begins with a start step 105, which corresponds to the start step 15 of FIG. 1. Then, the method 100 provides with five steps 110, 120, 130, 140, and 150. The steps 110, 120, and 130 of FIG. 2A are similar to the step 20 of FIG. 1. Thus, the specific details and disclosure for the step 20 of FIG. 1 provided above can also apply to the steps 110, 120, and 130 of FIG. 2A. Using the method 100, after the start step 105, behavioral test scores are assigned at the step 110. Preferably, the behavioral test scores are provided subjectively and are also scored and/or pre-processed as input for the invention. Preferably, the behavioral test scores are provided by a low density sample space.

Then, once the test scores are assigned in the step 110, the method 100 continues to the step 120, where a first group of scales is selected from among a plurality of scales, wherein a preference is known regarding each member of the sample space. Then, at a step 130, the first group of scales are evaluated based upon a user input. The various means of evaluating the scales based upon a user input were previously described herein in FIG. 1.

Then, a set of statistics for a first subject group and a second subject group can be determined at the step 140. As described in greater detail previously in relation to FIG. 1, the first subject group and the second subject group can refer to the “study group” and the “other group,” respectively. Preferably, the “study group” includes one or more new test subjects who are being reviewed to see if they pass or fail the filter generated by the invention. The steps 140 and 150 of FIG. 2A are similar to the comparing step 30 of FIG. 1. Thus, the specific details and disclosure for the step 30 of FIG. 1 provided above can also apply to the steps 140 and 150 of FIG. 2A. The first subject group and the second subject group is compared based upon the first group of scales at the step 150. Finally, the method 100 ends at the end step 155, which corresponds to the end step 35 of FIG. 1.

FIG. 2B is a flow chart of a method 200 for analyzing test scores obtained from a sample space based on a plurality of scales. FIG. 2B is similar to FIGS. 1 and 2A, but FIG. 2B includes additional steps and details which are not disclosed in FIGS. 1 and 2A. It will be apparent to those skilled in the art that one or more step(s) can be added and/or deleted from the method 200, without departing from the spirit and scope of the present invention.

As shown in FIG. 2B, the method 200 begins with a start step 205, which corresponds to the start step 15 of FIG. 1. After the start step 205, in FIG. 2B, test scores are then appropriately assigned or mapped to subjects at a step 210. Preferably, the test scores are included in a plurality of scales for each subject. Then, at a step 215, a first set of statistics are determined for each subject group of the sample space. As described above, in the preferred embodiment of the invention, the sample space includes subjects that are grouped in at least two subject groups, namely, the first subject group (which can also be called the “study group”) and the second subject group (which can be called the “other group”). However, one skilled in the art may appreciate that this invention is not limited to sample spaces having two subject groups only. This invention can be applied to one or more subject groups of a given sample space.

At a step 220, t-test results are determined for each scale of the plurality of scales. Alternatively, at the step 220, t-test results are determined for each test score obtained from the sample space. Then, a step 225 occurs, where a first group of scales are selected automatically from a plurality of scales. The step 225 of FIG. 2B corresponds to the step 120 of FIG. 2A. Thus, the specific details and disclosure for the step 120 of FIG. 2A provided above can also apply to the step 225 of FIG. 2B.

Still referring to FIG. 2B, at a step 230, the first group of scales are displayed to the user on a display. Then, at a step 235, the first group of scales can be evaluated, based upon a user input. The step 235 of FIG. 2B corresponds to the step 130 of FIG. 2A. Thus, the specific details and disclosure for the step 130 of FIG. 2A provided above can also apply to the step 235 of FIG. 2B.

Next, at a step 240, a second set of statistics for each subject group of the sample space is determined, based on the first group of scales. The step 240 of FIG. 2B is similar to the step 140 of FIG. 2A. In other words, the specific details disclosed provided above regarding the step 140 of FIG. 2A can be applied to the step 240 of FIG. 2B. Still referring to FIG. 2B, at a step 245, comparisons of the subject groups are made, based upon the first group of scales. The comparisons are preferably conducted using random sampling of one or more subject groups. Further, at a step 250, statistical analysis and comparisons are reported to the user, based upon the first group of scales. Finally, the method 200 ends at a step 255, which corresponds to the end step 35 of FIG. 1.

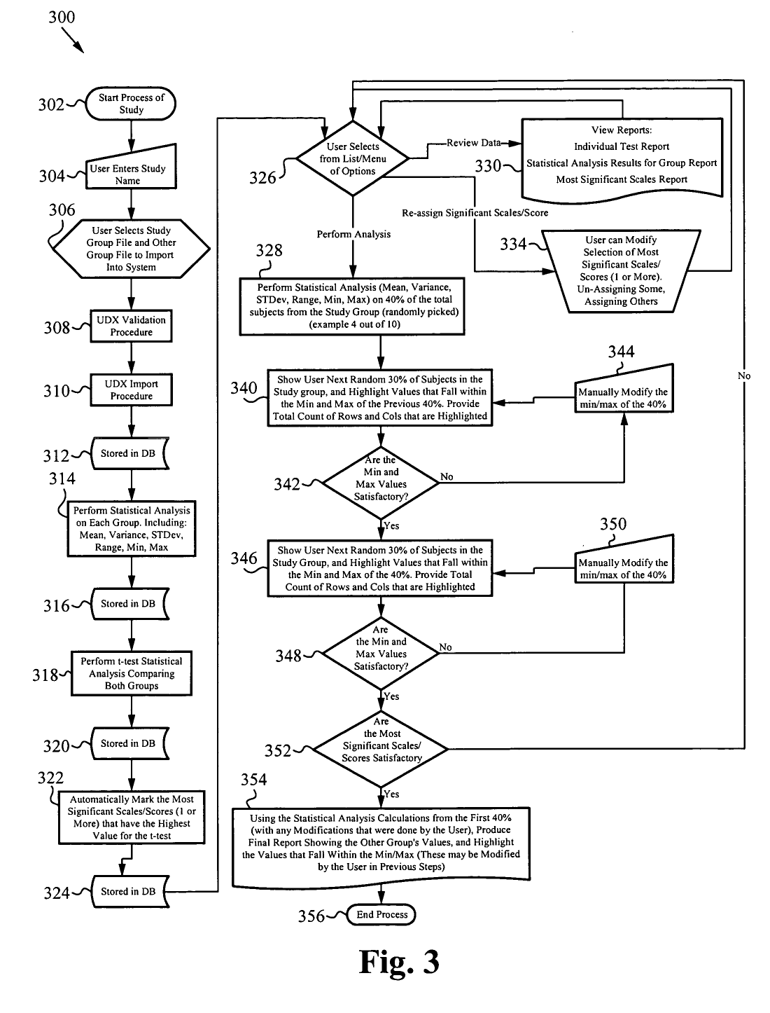

FIG. 3 is a process flow chart of a method 300 for analyzing data of a sample space, in accordance with the preferred embodiment of the present invention. Preferably, the data includes test scores from a psychological testing conducted on a low density sample space having no more than fifty subjects. It will be apparent to those skilled in the art that one or more step(s) can be added and/or deleted from the method 300, without departing from the spirit and scope of the present invention.

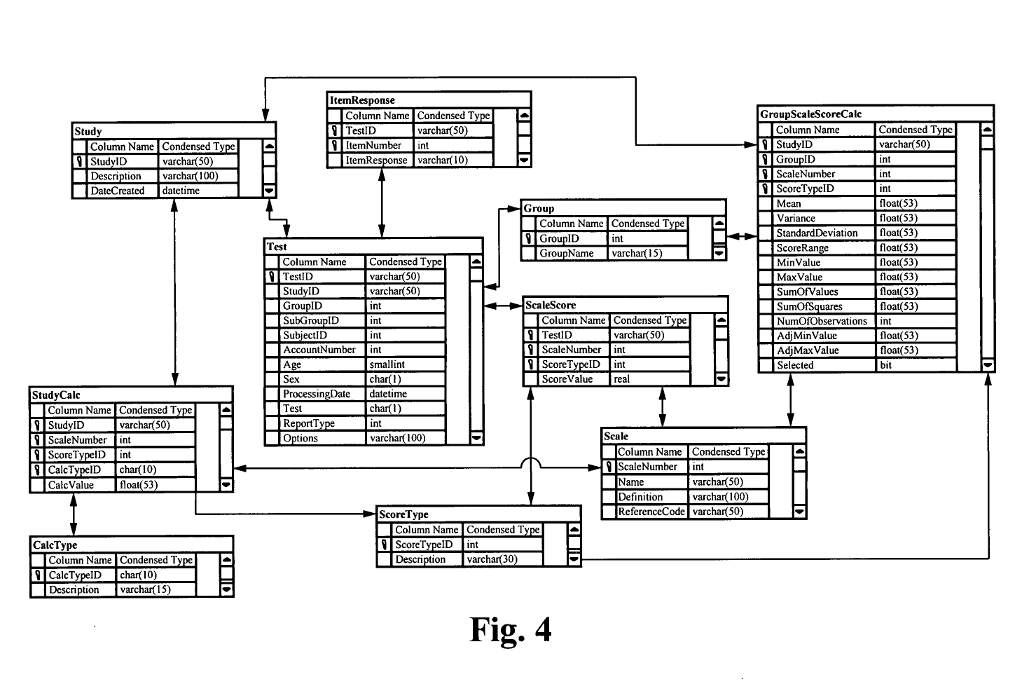

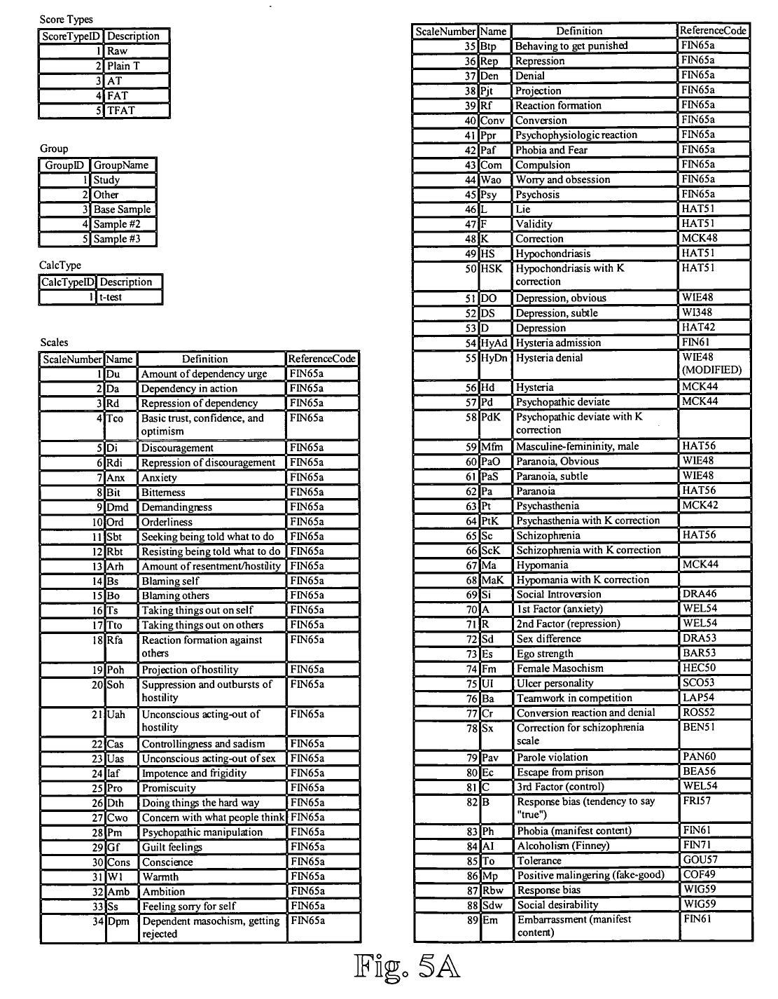

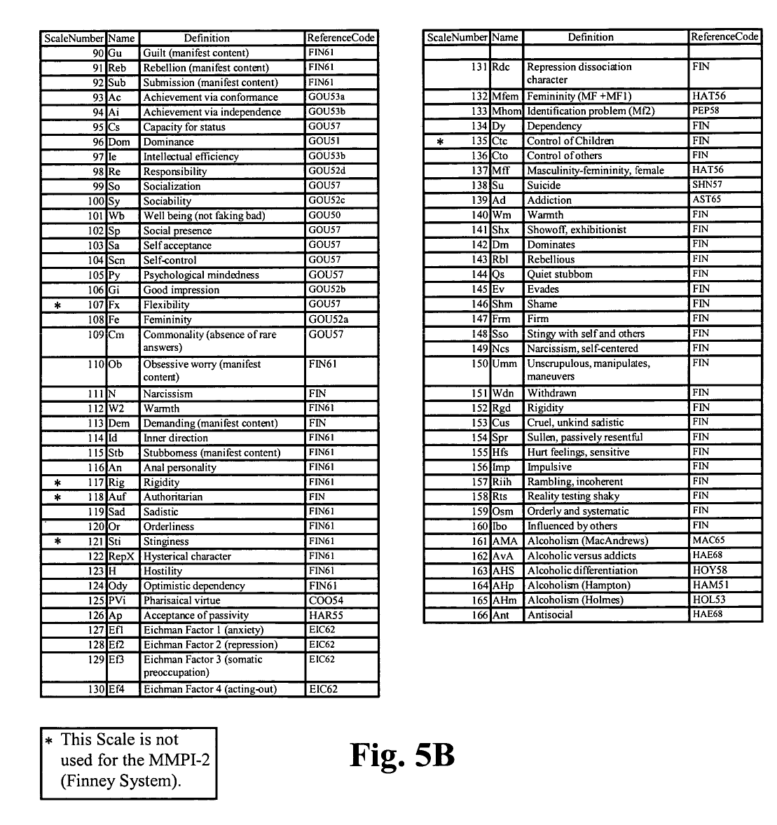

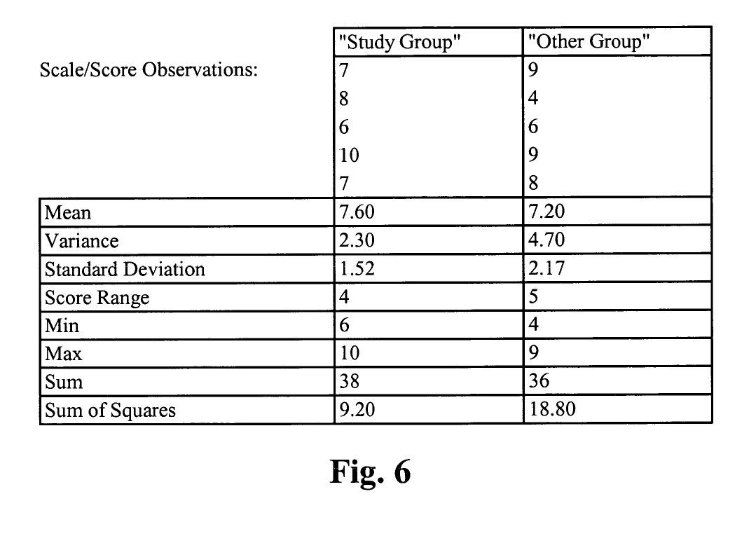

The method 300 begins with a start step 302. The user inputs or enters a name of a study at a step 304. Preferably, the study includes a psychological test study, such as the MMPI-2. Then, at a step 306, the user selects files to import from a database into a system. Preferably, the system includes a system for analyzing data or test scores. FIG. 4 shows an entity-relationship diagram of an exemplary database for the system. Preferably, the database is programmed using SQL; however, one skilled in the art will appreciate that any conventional programming language can be used to program the database using the entity-relationship diagram of FIG. 4 as a framework. FIGS. 5A and 5B show data constants, score types, and a plurality of MMPI scales that can be utilized in the database, in accordance with the preferred embodiment of the present invention. In some of the scales shown in FIGS. 5A and 5B, asterisks are shown next to five scales that are depreciated (and are therefore not counted) under the MMPI-2 (Finney system).

Referring back to FIG. 3, preferably, the files selected by the user at the step 306 are database files having data obtained from a low density sample space. Preferably, the sample space includes at least a first subject group and a second subject group. For example, as shown in FIG. 3, the user selects two files, the “study group file” and the “other group file” for importation. The “study group file” includes the data belonging to the first subject group (also known as the “study group”). The first subject group (the “study group”) is a group that includes characteristics which are being searched for in a second subject group (the “other group”). The “other group file” includes the data belonging to the second subject group. The second subject group (the “other group”) is a group having characteristics that are searched for in the first subject group (the “study group”). Although FIG. 3 shows that the user selects two files called the “study group file” and the “other group file” for importation at the step 306, it will be apparent to those skilled in the art that the names of the files are arbitrarily chosen in this example, and further that the user can select one or more files during the step 306. Alternatively, the step 306 can be substituted with any step involving data transfer from one data source to another. Alternatively, the step 306 can be bypassed if the system already includes the data obtained from the sample space.

Preferably, the data obtained from the sample space include test scores. Specifically, there are at least five test scores for each of a plurality of 161 scales associated with the MMPI-2 (Finney system). The MMPI preferably includes 566 true/false questions, although there are other formats of the MMPI having a different number or series of true/false questions. The plurality of scales for the MMPI can include validity and clinical scales. The validity scales can be used to determine if the test results were valid. That is, the validity scales can show if a subject chose answers cooperatively, not randomly, and truthfully. Also, the validity scales can show the subject's response style (e.g., defensive, cooperative, etc.) The clinical scales or personality scales of the MMPI utilize a set of MMPI questions to evaluate a personality trait or characteristic. Further scales and subscales may be included with the MMPI.

The five test scores for each of the scales of the MMPI include Raw, T, AT, FAT, and TFAT scores. The Raw score represents the actual test score derived from a subject's answers to the true/false questions. The Raw score is converted to a T score through the use of T conversion tables. The MMPI provides separate T conversion tables for males and females. T scores are typically based on a mean of 50 and a standard deviation of 10. Generally, T scores having a standard deviation of 1 or more are considered significant. The AT score represents the T score corrected for anxiety. The FAT score represents the T score corrected for anxiety and social desirability. The TFAT represents the average of T score and FAT score. In other words, the AT, FAT, and TFAT represent scores which are computed or corrected to reduce effects of response sets correlated with anxiety and/or social desirability.

Assuming that there are 161 scales, as is the case with the MMPI-2 test (Finney system), there would be 805 test scores (161 multiplied by 5) in total for each subject. Although the MMPI can include a total of 166 scales, preferably, some scales are depreciated and only 161 scales of the total 166 scales are actually used for the MMPI-2 (Finney system). Those scales that are not counted under the MMPI-2 (Finney system) are shown with asterisks in FIGS. 5A and 5B. Thus, for purposes of test score assignment in this example, it is assumed that 161 scales exists for the MMPI-2 (Finney system).

Once the 805 test scores are imported and appropriately mapped to the subjects, then each subject can be uniquely identified. The unique identification of the subject can include but is not limited to: the imported account number, the subject identification number, age, sex, and subject group identification (“study group” designation or “other group” designation in our example). However, one skilled in the art will recognize that this list is not exhaustive, and that any means of uniquely identifying subjects can be utilized. If there are twenty subjects in total for the sample space, with ten subjects in each of the “study group” and the “other group”, then each of the twenty subjects will have a unique identification. Further, in this example, for twenty subjects, there would be a total number of 16,100 associations (20 subjects multiplied by 805 test scores for each subject=16,100 associations). However, in this example, the 16,100 associations are a result of a one-on-one scale comparison. One skilled in the art will appreciate that the invention is not limited to 16,100 associations, and that any number of associations can be determined. In some embodiments, scales, factors and/or derived scores can be combined in any number of possible combinations for comparison purposes, thereby potentially increasing the number of associations exponentially. The method 300 also can include optional steps of accessing and displaying a matrix (not shown), where the matrix includes, but is not limited to, information about the subjects, the scales, the test scores and the associations.

At a step 308, a UDX validation procedure occurs, where the data (test scores) from the “study group file” and the “other group file” are validated. A step 310 of UDX import procedure then follows. Preferably, the import process is written in Java, and includes processing a UDX file, parsing the UDX file, and importing the data of the UDX file into a data structure, though any convenient computer language can be used. During the step 310, since subject identification numbers are not unique in UDX files, the import procedure also provides a new subject ID. For instance, a new subject ID can be generated based upon the following structure of fields:

<AccountNumber>_<ProcessingData in yymmdd format>_<SubjectID>_<Age>_<Sex>

For example, a new subject ID can be 2641_{—}010501_{—}28_{—}24_M, where 2641 is the account number, the data was processed on May 1, 2001, the subject ID is 28, the age of the subject is 24 and the subject is a male. However, this example is illustrative only. One skilled in the art can appreciate that the new subject ID can be generated based upon any type of information fields or variables regarding the subject, including but not limited to parameters not currently in the UDX file format.

Following the UDX file import procedure at the step 310, the test scores of the files are then stored in the database of the system at a step 312. Alternatively, if the system already included the data obtained from the sample space, then the steps 308 and 312 can be bypassed. Further, the present invention is not limited to using UDX for data retrieval, and the files need not have .udx extension. It is well known in the art how data can be validated, exchanged, retrieved or imported from one data source to another; thus, any means of validating and importing data from the sample space into the system can be used in the steps 308 and 310, as necessary.

Then, at a step 314, initial statistical analysis is performed on each of the subject groups of the sample space. For example, if there are two subject groups (the “study group” and the “other group”) of the sample space, then at the step 314, statistical analysis is performed on the two subject groups, thereby resulting in a first set of statistics for the “study group” and a second set of statistics for the “other group.” The statistical analysis includes determining the statistics of mean, variance, standard deviation, range, minimum, maximum, sum, sum of squares, and any combination thereof. However, this list of statistics is not meant to be exhaustive, but rather illustrative.

For example, one statistic for each of the subject groups can be the mean of the T score of scale 1 (Amount of Dependency Urge). The statistics derived from the step 314 are then also stored in the database of the system at a step 316. The database thus can include data in the following categories: scale number, scale abbreviated name, scale description, mean, variance, standard deviation, score range (representing the difference between the upper test score and the lower test score), the upper test score (the maximum test score or the test score having the maximum value), and the lower test score (the minimum test score or the test score having the minimum value). Preferably, the test scores are computed to one decimal place. Also, the method 300 also can include optional steps of accessing and displaying a matrix (not shown), where the matrix includes the subjects, the test scores, the scales, the statistics, and their associations.

Once the initial statistical analysis on each subject group is performed, then at a step 318, t-test statistical analysis is performed, comparing each of subject groups of the sample space. Preferably, t-test statistical analysis can compare the first subject group (the “study” group) with the second subject group (the “other” group). The t-test formula used is as follows:

$$t = \frac{\overline{X} - \overline{Y}}{\sqrt{\frac{var ( X )}{Xn} + \frac{var ( Y )}{Yn}}}$$

where X represents subject group X and Y represents subject group Y. The numerator is the mean of the subject group X minus the mean of the subject group Y. The denominator is the square root of the variance of group X divided by the number of observations for the given scale in the subject group X plus the variance of the subject group Y divided by the number of observations for the given scale in the subject group Y. Once the t-test results are calculated, they are then stored in the database at a step 320. The method 300 also allows for an optional step of viewing the t-test results for each of the subject groups of the sample space.

For illustrative purposes, FIG. 4 shows statistics derived from the initial statistical analysis of the “study group” and the “other group.” Assume that the study includes ten subjects, five subjects in the first subject group (“study group”) and five subjects in the second subject group (“other group”). The scale/score observations for each subject group are listed vertically under their respective subject group table headings. From those observations, the method 300 allows for initial statistics to be calculated. In FIG. 4, the statistics of mean, variance, standard, minimum test value, maximum test value, sum, and sum of the squares are listed for both the “study group” and the “other group.” These initial statistics are calculated at the step 314 and stored in the database at the step 316. Then, t-test results are calculated for each scale/score for the subject groups at the step 318. Applying the t-test formula listed above, the t-test comparative result is determined for the “study group” and the “other group as 0.34.

$$t = \frac{7.60 - 7.20}{\sqrt{\frac{2.30}{5} + \frac{4.70}{5}}} = \frac{.4}{\sqrt{.46 + .94}} = \frac{.4}{\sqrt{1.4}} = \frac{.4}{1.18} = 0.34$$

This 0.34 t-test result is then stored in the database at the step 320.

Referring back to FIG. 3, once the t-test results are stored, marked or designated, the most significant scales or scores are automatically selected at a step 322. Preferably, at the step 322, a computerized ranking of the scales or scores is conducted. Then, the scales with the highest t-test results are designated the most significant scales or scores. It will be appreciated by those skilled in the art that the number of scales that are designated as the most significant scales can be of any number, and the number can be programmable and/or preset at any time. The most significant scales or scores are then displayed in descending numerical order by their associated t-test results. For example, the top twenty most significant scales can be displayed to the user by the value of their t-test results. Preferably, the user can also view the next twenty most significant scales, and also the remaining scales in their associated rankings by their t-test values. The most significant scales or scores which were automatically selected at the step 322 are then stored in the database at a step 324.

Then, once the most significant scales or scores are stored in the database, the user is presented with a list or a menu of options. Preferably, the user is presented with the list of options on a display of a computer coupled to the database. The user then can select one option from the list of options at a step 326. Preferably, the list of options that is presented to the user includes at least three options; namely, a first option to review data, a second option to reassign significant scales or scores, and a third option to perform analysis. This list of options is illustrative only. It will be apparent to those skilled in the art that the one or more options can be added and/or omitted from the list of options, without departing from the scope and spirit of the present invention.

If the user selects the option to review data, the method 300 continues to a step 330, where the user can view a report concerning the data. Preferably, the user is given further options to view an individual test report, a statistical analysis results for group report, or a most significant scales report. An individual-test report includes information about one subject of the sample space, including but not limited to the unique identification of the subject (such as the Subject ID mentioned above), the subject's responses to the questions presented in the study, the subject's name, sex, age, and the subject's test scores based on the plurality of scales. The Statistical Analysis Results for Group Report can include the initial statistics obtained from the step 314 regarding a specific subject group (such as the “study group” or the “other group” mentioned in previous examples). The Most Significant Scales Report provides a listing of the most significant scales automatically selected in the step 322. It will be appreciated by those skilled in the art that these reports are illustrative only, and the reports viewed by the user at the step 330 can include or omit details and data without departing from the scope and spirit of the present invention. In some embodiments, the user can view the reports individually. In some embodiments, the user can view two or more of the reports simultaneously. Preferably, the reports are displayed on a display coupled to a computer of the system.

If, however, at a step 326 the user selects the option to re-assign significant scales/scores, then the method 300 continues to a step 334, where the user is presented with an opportunity to modify the selection of the most significant scales/scores. Preferably, at the step 334, the user is shown the current listing of each of the plurality of scales, with the most significant scales/scores are checked, highlighted, marked or otherwise distinguished from the other scales/scores in some way. The user at the step 334 can assign and/or un-assign the most significant scales/scores. Preferably, the user can check or uncheck the most significant scales/scores. By placing a check next to a scale, the user can assign that scale to the most significant scales. If a most significant scale is checked but the user removes the check, then that scale is re-assigned from the most significant scales to a second group of scales. Preferably, the second group of scales represent those scales which were previously assigned for the most significant scales, but which are currently not assigned to the most significant scales. In some embodiments, the user can refine or adjust the most significant scales/scores. Once the step 334 is performed, the user is returned to the step 326 to select an option from the list of options.

If the user selects at the step 326 to perform an analysis, the method 300 continues to a step 338 where statistical analysis is performed on a first sample subset of the first subject group (the “study group”). The objective here is to continuously refine the selection of the most significant scales and also to refine the maximum or minimum test scores associated with these scales, such that a comparative formula can be determined for comparing the sample subset of the “study group” against the “other group.” Assume that the sample space includes twenty subjects, with ten subjects in each of the first subject group and the second subject group. Preferably, the first sample subset is randomly picked. The first sample subset of the “study group” can be arbitrarily named Sample A. For example, assume that Sample A includes 40 percent of the total number of subjects of the study group. The statistical analysis includes calculating the mean, variance, standard deviation, range, minimum, and maximum of Sample A, based on the most significant scales. However, this list of statistics is not meant to be exhaustive, but rather illustrative. The statistics are then stored in a database.

Next, at a step 340, the user is shown a second sample subset of the “study group.” Preferably, the second sample subset is also randomly selected. Assume that the second sample subset of the “study group” is arbitrarily named Sample B, and Sample B includes 30 percent of the remaining six subjects of the study group; in other words, Sample B includes three randomly selected subjects. The step 340 also includes comparing scores from Sample B against the minimum and maximum test scores calculated from Sample A, and highlighting scores from Sample B that fall within the minimum and maximum test scores of Sample A based on the most significant scales. The step 340 can also include providing a total count of highlighted rows and columns of a matrix, where the matrix includes the test scores of the samples and subject groups. Preferably, the rows and columns of the matrix are highlighted when the test scores fall within the minimum and maximum test scores.

Then, at a step 342, the user is asked if the minimum and maximum test scores of the first sample subset (Sample A) of the study group are satisfactory. If the user inputs a negative response to this inquiry, the user is then allowed at a step 344 to manually modify or adjust the minimum and/or the maximum test scores of the first sample subset (Sample A) of the study group. Also, the user can evaluate the most significant scales. The user can modify, adjust, assign, and/or reassign any scale(s) of the most significant scales. The process 300 then continues to the step 346.

If, on the other hand, the user inputs an affirmative response to the inquiry of whether the minimum and maximum test scores of the first sample subset (Sample A) of the study group are satisfactory at the step 342, then the method 300 proceeds to a step 346. At the step 346, the user is shown a third sample subset of the study group. Preferably, the third sample subset includes the remaining 30 percent of the study group, again randomly chosen. At the step 346, values which falls within the minimum and maximum test scores of the first sample subset are highlighted. The step 346 can also include providing a total count of highlighted rows and columns of a matrix, where the matrix includes the test scores of the samples and subject groups. Preferably, the rows and columns of the matrix are highlighted when the test scores fall within the minimum and maximum test scores.

At a step 348, the user is asked if the minimum and maximum test scores are satisfactory. If the user inputs a negative response to the inquiry, at a step 350, the user is given the opportunity to manually modify or adjust the minimum and/or maximum test scores of the first sample subset of the study group. After the step 350, the method returns to the step 346. If, on the other hand, the user inputs a positive response to the inquiry presented at the step 348, the user is further asked if the most significant scales or scores are satisfactory at a step 352.

If the user answers “no” to the inquiry at the step 352, then the user is returned to the step 326, where the user can select an option from the list of options, as previously described, including the option to reassign significant scales/scores at the step 334. It should be noted that the user can view scales throughout the process of statistical analysis in a format that includes the subject name, group, scale number, scale description, score range, minimum and maximum test scores. Further, all numerical displays should be rounded to one decimal point.

If, on the other hand, the user answers “yes” to the inquiry at the step 352, then a final report is produced at a step 354. Preferably, the first report is produced using the statistical analysis calculations from the first sample subset with any modifications done by the user. The final report preferably shows the results belonging to the second subject group (the “other group”), and highlights those values which fall within the minimum and maximum test scores of the first sample subset (Sample A) of the study group. At a step 356, the method 300 ends.

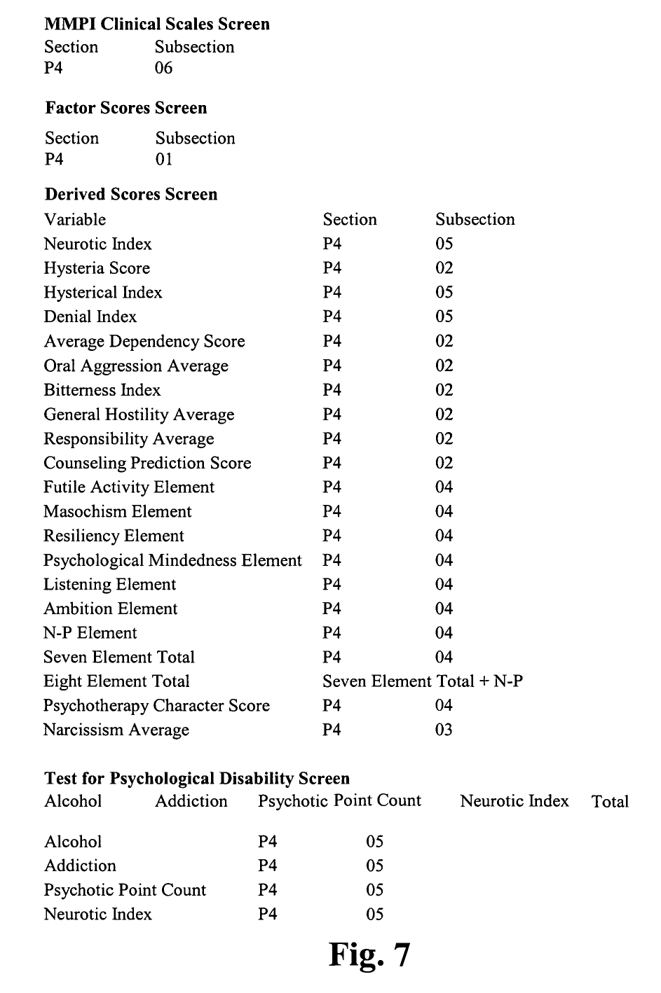

Preferably, the method 300 allows for displaying statistics and results obtained from the sample space. For instance, the method 300 can allow for statistics and results to be presented in a plurality of screens, such as the screens listed in FIG. 7. FIG. 7 shows displays or screens for MMPI clinical scales, factor scores, derived scores and tests for psychological disability, where the present invention is used in conjunction with the MMPI. However, it will be appreciated by those skilled in the art that FIG. 7 is illustrative only, and that statistics and results can be displayed in any type of format for the user to view.

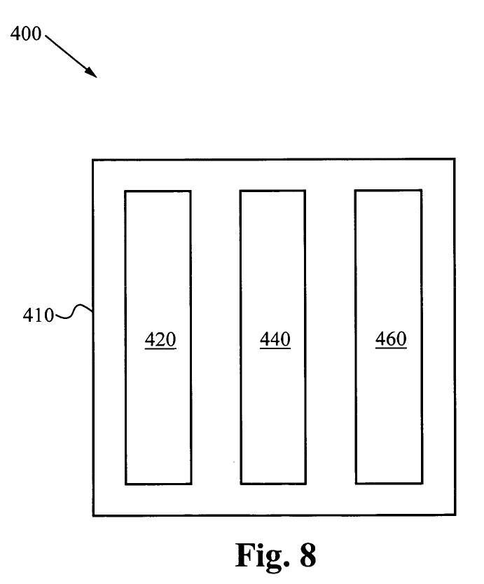

The present invention also includes a computer readable medium 400 having a program 410 stored thereon, as shown in FIG. 8. The program 410 is for analyzing test scores obtained from the sample space based on the plurality of scales for each member of the sample space, each scale including at least one test score which accommodates a preference known regarding each member of the sample space. The program 410 preferably includes sets of instructions. The sets of instructions can include: instructions for generating a filter including selecting a first group of scales from among a plurality of scales 420 and instructions for comparing a new subject against the first group of scales for conformance to the preference 440. The instructions for comparing 440 can also include instructions for evaluating a first group of scales based on a user input (not shown). Also, the program 410 can further include instructions for determining statistics for a sample space based on the first group of scales 460.

In some embodiments, the instructions for generating a filter 420 accomplishes the step 20 of the method 10 (FIG. 1). In some embodiments, the instructions for generating a filter 420 accomplishes the steps 110, 120, and 130 of the method 100 (FIG. 2A). In some embodiments, the instructions for generating a filter 420 accomplishes the steps 210, 220, 225, and 230 of the method 200 (FIG. 2B). The instructions for comparing 440 can perform the step 30 of the method 10 (FIG. 1). In some embodiments, the instructions for comparing 440 can perform the steps 140 and 150 of the method 100 (FIG. 2A). In some embodiments, the instructions for comparing 440 can perform the steps 245 and 250 of the method 200 (FIG. 2B). Further, the instructions for determining statistics 460 can complete the tasks of the step 215 and 240 of the method 200 (FIG. 2B). However, it will be apparent to those skilled in the art that the sets of instructions in the program 410 can overlap in completing certain steps and/or tasks of the method 10 (FIG. 1), the method 100 (FIG. 2A) and the method 200 (FIG. 2B). Further, one or more the sets of instructions of the program 410 can be added or omitted, without departing from the spirit and scope of the present invention.

Preferably, the instructions for generating a filter 420 further comprises instructions for: computerized ranking of the plurality of scales based on a criterion, and assigning, from among the plurality of scales, the first group of scales, based on their associated rankings. The instructions for generating a filter 420 can further include instructions for calculating a t-test result for each of the plurality of scales. The instructions for generating 420 can include instructions for computerized ranking of the plurality of scales based on their associated t-test results, and assigning, from among the plurality of scales, the first group of scales based on their associated rankings based on t-test results. The instructions for generating a filter 420 can further includes instructions for evaluating the first group of scales based upon a user input. Also, the instructions for generating a filter 420 can include instructions for refining the first group of scales (not shown).

The instructions for generating a filter 420 can also include instructions for assigning a scale to the first group of scales, as well as instructions for re-assigning a scale from the first group of scales to a second group of scales. Preferably, the sample space is of low density (having no more than fifty subjects) and can have a first subject group (such as a “study group”) and a second subject group (such as an “other group”).

The instructions for comparing 440 can also have instructions for sampling the first subject group, thereby producing a plurality of sample sets and performing statistical analysis on each of the plurality of sample sets. The instructions for comparing 440 can include instructions for performing statistical analysis on the second subject group and comparing the statistics of a sample set of the first subject group with the statistics of the second subject group. The statistics obtained from the statistical analysis can include one of mean, variance, standard deviation, range, maximum, minimum, sum, sum of squares, and any combination thereof. However, this list of statistics is not meant to be exhaustive, but rather illustrative.

The program 410 stored on the computer readable medium 400 can also include a set of instructions for displaying the statistics (not shown). In some embodiments, the program 410 can include a set of instructions for importing test scores from a data source (not shown). Preferably, the test scores are obtained using a psychological test, such as the MMPI, performed on a low density sample space having no more than fifty subjects. Preferably, the program 410 can also be used to accomplish the steps found in the method 300 of FIG. 3. Preferably, the instructions for generating a filter 420 can accomplish the steps 314, 318, 322, and 334 of the method 300 (FIG. 3), while the instructions for comparing 440 can perform the steps 328, 340, 344, 342, 346, 350, 348, and 352 of the method 300 (FIG. 3). Preferably, the instructions for determining 460 can perform the step 338 of FIG. 3. Furthermore, the instructions for displaying statistics (not shown) can accomplish the task of the steps 330 and 354 (FIG. 3). It will be apparent to those skilled in the art that the sets of instructions in the program 410 can overlap in completing certain steps and/or tasks of the method 300 (FIG. 3). Further, one or more the sets of instructions of the program 410 can be added and/or omitted, without departing from the spirit and scope of the present invention.

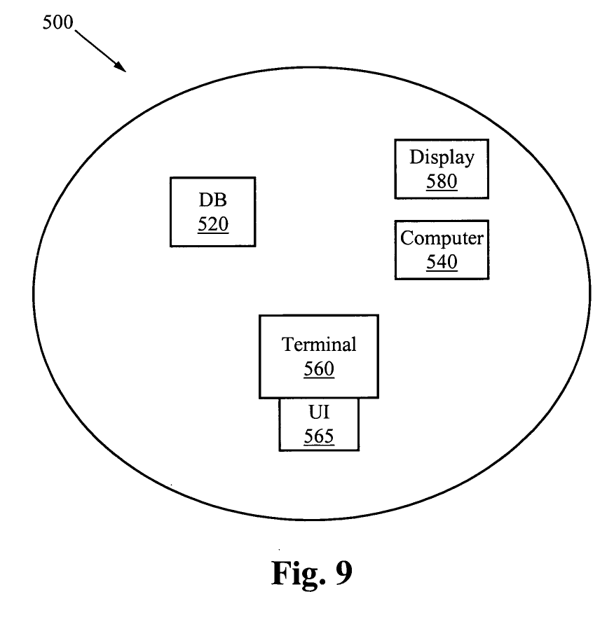

The present invention also is directed to a system 500 for analyzing test scores, as shown in FIG. 9. The system 500 includes a database 520, a computer 540, and a terminal 560. The database 520 is for storing test scores and a plurality of scales. Each scale comprises a test score. The database 520 is operatively coupled to the computer 540. One example of the database 520 can be represented by the entity relationship diagram of FIG. 4, as previously mentioned. However, it will be apparent to those skilled in the art that the database 520 can be configured and manipulated in any number of ways, depending upon the application at hand.

Referring back to FIG. 9, the computer 540 is configured for generating a filter including selecting a first group of scales from the plurality of scales which accommodates a preference. Also, the computer 540 is configured for comparing a new subject against the first group of scales for conformance to the preference. In other words, preferably, the computer 540 is configured to accomplish steps 20 and 30 of the method 10 (FIG. 1) The computer 540 can also be configured for determining statistics for the sample space based on the first group of scales (not shown). The computer 540 is also configured for ranking of the plurality of scales based on a criterion and assigning, from among the plurality of scales, the first group of scales based on their associated rankings. The terminal 560 includes a user interface 565 and the terminal 560 is operatively coupled to the computer 540. The user interface 565 is configured for receiving a user input evaluation of the first group of scales. Preferably, the criterion includes a t-test result of a scale. Also, the system 500 further comprises a display 580 for displaying the plurality of scales, the test scores, t-test results, and the statistics. The system 500 can also include any peripheral device (not shown) to provide and/or print a report of the scales, test scores, t-test results, statistics and any combination thereof.

Preferably, the system 500 can process the method 300 of FIG. 3. Alternatively, the system 500 can process the method 10 (FIG. 1), the method 100 (FIG. 2A) and/or the method 200 (FIG. 2B). The database 520 can be accessed through the method 300, and specifically, the database 520 is instrumental in the steps 312, 316, 320, and 324 for storing data, including but not limited to test scores, scales, statistics and subject identification. The computer 540 is key to performing the method 300 (FIG. 3), since the computer 540 can perform many of the steps of the method 300. Specifically, the computer 540 performs the tasks in the steps 314, 318, 322, 330, 338, 340, 346, and 354 (FIG. 3). The terminal 560 with the user interface 565 allows for user input. Thus, the terminal 560 is instrumental in the steps 304, 306, 326, 330, 334, 344, and 350 (FIG. 3). Finally, the display 580 allows for the user to view reports and data. Thus, the display 580 is important in the steps 306, 326, 330, 340, 346, and 354 (FIG. 3). It will be apparent to those skilled in the art that the components (e.g., 520, 540, 560, and 580) of the system 500 can overlap in completing certain steps and/or tasks of the method 300 (FIG. 3). Further, one or more components of the system 500 can be added or omitted, without departing from the spirit and scope of the present invention.

The present invention further includes a method of updating a filter. As mentioned previously herein, a filter preferably has a finite time in which it remains accurate and effective. In some embodiments, a filter can represent a culture of people. For example, a filter can represent a culture of police department officers in a certain city. However, cultures change over time, as people change, and this can be viewed as cultural migration. Thus, in order for a filter to accurately represent a group of people, a culture of people, or a sample space, the filter must be updated to remain current. The invention, therefore, allows for a strengthening of the filter over time on an ongoing basis. The filter can be updated, modified, adjusted, refined, and/or improved. Preferably, the filter is updated by changing one or more predictor variables. Alternatively, the filter is updated by changing and/or selecting one or more scales from the plurality of scales. Subjective decisions can be made to include data of a new subject, including but not limited to test scores of the new subject, into a filter, when the new subject does not conform to an existing preference known about a sample space.

Also, if one filter represents a preference of predictor variables, which are shared by all in a sample space, then as subjects are added or removed from the sample space, the filter must also be updated to reflect the current sample space. Further, if a new test subject presents an anomaly to a preference known about a sample space, then a filter can be updated, modified, adjusted and/or refined such that the anomaly no longer exists. In other words, an updated preference included as part of an updated filter can include a new subject's data, variables and/or test scores, such that the new subject no longer presents an anomaly to the updated filter.

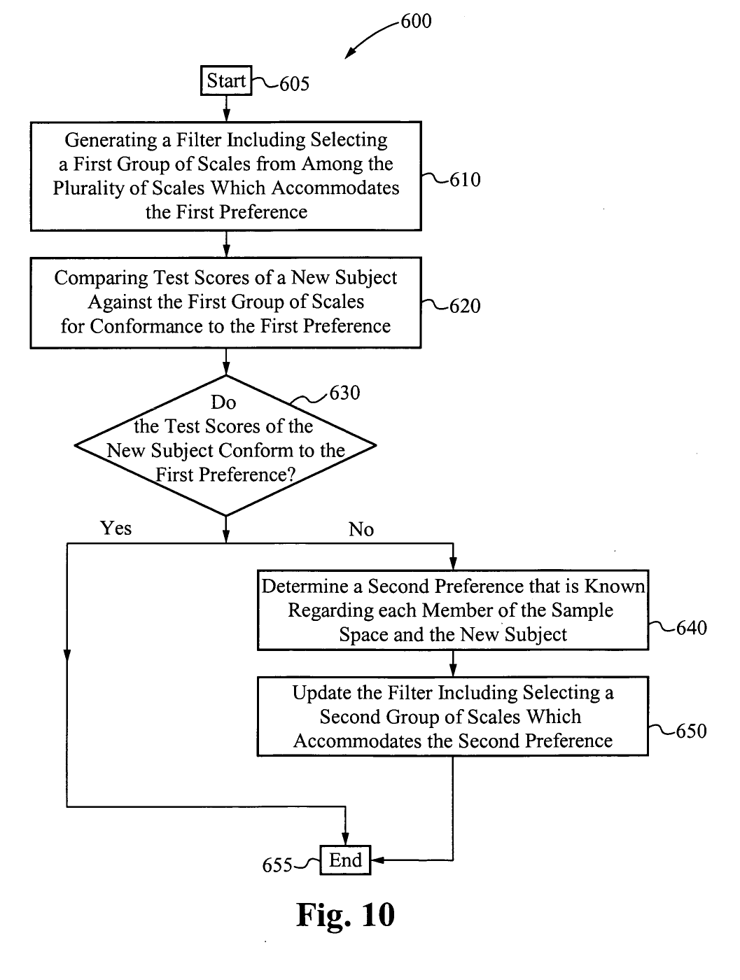

FIG. 10 shows a method 600 of analyzing test scores obtained from a sample space, in accordance with the preferred embodiment of the invention. The test scores can be based on a plurality of scales for each member of the sample space. Each scale can include at least one test score. A first preference is known regarding each member of the sample space. The method 600 can include several steps. The method 600 begins with a start step 605. Then, in a step 610, a filter is generated. The generating of the filter includes selecting a first group of scales from among the plurality of scales which accommodates the first preference. Then, after the filter is generated at the step 610, at a step 620, test scores of a new subject are compared against the first group of scales for conformance to the first preference. At a step 630, an inquiry is made whether the test scores of the new subject conform to the first preference.

If it is determined that the test scores of the new subject conform to the first preference, at the step 630, then the method 600 ends at an end step 655. If, however, the test scores of the new subject do not conform to the first preference, at the step 630, then the method continues to a step 640. At the step 640, a second preference is determined, where the second preference is known regarding each member of the sample space and the new subject. Once the second preference is determined, at a step 650, then the filter is updated. Preferably, the filter is updated by selecting a second group of scales which accommodate the second preference. The second group of scales are preferably different than the first group of scales. Finally, once the filter is updated at the step 650, then the method 600 ends at the end step 655. It will be appreciated by those skilled in the art that one or more step(s) can be added or removed from the method 600, without departing from the spirit and the scope of the invention.

The filter, however, can be updated in any number of ways besides selecting a second group of scales which accommodate the second preference. For instance, any predictor variable which is included in the filter can be changed. For example, one or more predictor variable(s), such as the age of an ideal candidate for a city police officer's position, can be manually changed in the filter. Also, one or more predictor variable(s) can be added or removed from the filter. Further, one or more test subjects can be added to a sample space. Also, one or more members of an existing sample space can be removed from the sample space.

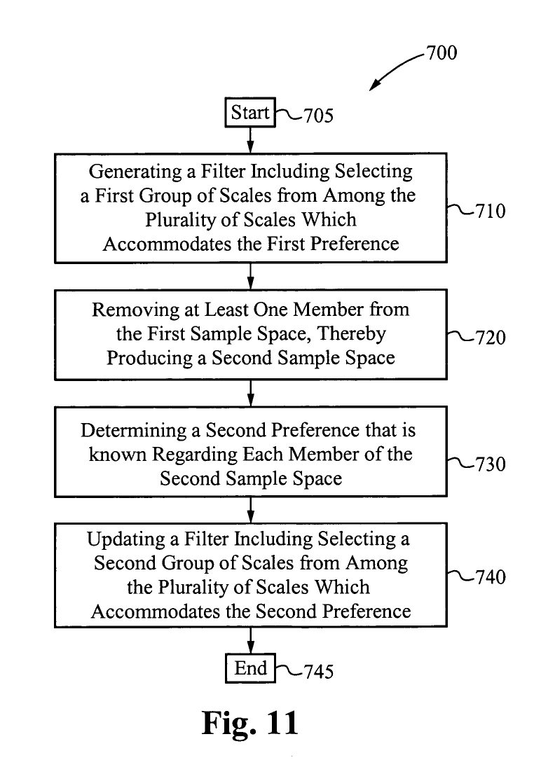

FIG. 11 illustrates a method 700 where one member is removed from the sample space. The method 700 analyzes test scores obtained from a sample space, in accordance with the further embodiment of the invention. The test scores can be based on a plurality of scales for each member of the first sample space. Each scale can include at least one test score. A first preference is known regarding each member of the first sample space. The method 700 can include several steps. The method 700 begins with a start step 705. After the start step 705, a filter is generated at a step 710. The generating step 710 includes selecting a first group of scales from among the plurality of scales which accommodates the first preference. Then, at a step 720, at least one member is removed from the first sample space, thereby producing a second sample space. At a step 730, a second preference is determined, where the second preference is known regarding each member of the second sample space. At a step 740, the filter is updated. Preferably, the updating of the filter at the step 740 includes selecting a second group of scales from among the plurality of scales which accommodates the second preference. Finally, the method 700 ends at an end step 745. It will be appreciated by those skilled in the art that one or more step(s) can be added or removed from the method 700, without departing from the spirit and the scope of the invention.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims. For instance, one skilled in the art can appreciate that any conventional fuzzy logic, artificial intelligence and/or algorithm can be used to implement the invention, depending on the application at hand.

What is claimed is:

1. A method of analyzing test scores obtained from a sample space based on a plurality of scales for each member of the sample space, each scale including at least one test score, wherein a preference is known regarding each member, the method comprising the steps of:
a. generating a filter including selecting a first group of scales from among the plurality of scales which accommodates the preference; and
b. comparing a new subject against the first group of scales for conformance to the preference.

2. The method according to claim 1, wherein the generating step comprises:
a. computerized ranking of the plurality of scales based on a criterion; and
b. assigning, from among the plurality of scales, the first group of scales, based on their associated rankings.

3. The method according to claim 1, wherein the generating step is preceded by the step of calculating a t-test result for each of the plurality of scales.

4. The method according to claim 3, wherein the generating step comprises:
a. computerized ranking of the plurality of scales based on their associated t-test results; and
b. determining the first group of scales from among the plurality of scales, based on their associated t-test result rankings.

5. The method according to claim 1, wherein the generating step comprising evaluating the first group of scales based upon a user input.

6. The method according to claim 1, wherein the generating step comprises refining the first group of scales.

7. The method according to claim 1, wherein the generating step comprises assigning a scale to the first group of scales.

8. The method according to claim 1, wherein the generating step comprises re-assigning a scale from the first group of scales to a second group of scales.

9. The method according to claim 1, wherein the sample space comprises a first subject group and a second subject group, wherein the new subject is included in one of the first and second subject groups.

10. The method according to claim 9, wherein the comparing step further comprises:
a. randomly sampling the first subject group, thereby producing a plurality of sample sets; and
b. performing statistical analysis on each of the plurality of sample sets.

11. The method according to claim 10, wherein the comparing step further comprises:
c. performing statistical analysis on the second subject group; and
d. comparing the statistics of at least one of the sample sets of the first subject group with the statistics of the second subject group.

12. The method according to claim 1, wherein the statistics further comprise one of mean, variance, standard deviation, range, maximum, minimum, sum, sum of squares, and any combination thereof.

13. The method according to claim 1 further comprising the step of displaying the statistics on a display.

14. The method according to claim 1, wherein the test scores are obtained using a psychological test performed on the sample space.

15. A method of applying statistical analysis to behavioral test scores, the method comprising the steps of:
a. assigning behavioral test scores obtained from a sample space based on a plurality of scales for each member of the sample space, the sample space including at least a first subject group and a second subject group, each scale including at least one test score wherein a preference is known regarding each member of the sample space;
b. selecting a first group of scales from among a plurality of scales;
c. evaluating the first group of scales, based upon a user input;
d. determining a set of statistics for the first subject group and the second subject group; and
e. comparing the first subject group and the second subject group based upon the first group of scales.

16. A method of analyzing test scores obtained from a sample space based on a plurality of scales for each member of the sample space, each scale including at least one test score, wherein a first preference is known regarding each member, the method comprising the steps of:
a. generating a filter including selecting a first group of scales from among the plurality of scales which accommodates the first preference;
b. comparing test scores obtained from a new subject against the first group of scales for conformance to the first preference;
c. determining a second preference that is known regarding each member of the sample space and the new subject, in the event that the test scores of the new subject do not conform to the first preference; and
d. updating the filter including selecting a second group of scales from among the plurality of scales which accommodates the second preference, in the event that the test scores of the new subject do not conform to the first preference.

17. The method according to claim 16, wherein the method further comprises the step of adding the new subject to the sample space.

18. The method according to claim 16, wherein the method further comprises the step of refining the second group of scales.

19. A method of analyzing test scores obtained from a sample space based on a plurality of scales for each member of the first sample space, each scale including at least one test score, wherein a first preference is known regarding each member of the first sample space, the method comprising the steps of:
a. generating a filter including selecting a first group of scales from among the plurality of scales which accommodates the first preference;
b. removing at least one member from the first sample space, thereby producing a second sample space;
c. determining a second preference that is known regarding each member of the second sample space; and
d. updating the filter including selecting a second group of scales from among the plurality of scales which accommodates the second preference.

20. A computer readable medium having a program stored thereon, the program having sets of instructions for:
a. generating a filter including selecting a first group of scales from among a plurality of scales which accommodates a preference known regarding each member of a sample space; and
b. comparing a new subject against the first group of scales for conformance to the preference,
wherein the program is for analyzing test scores obtained from the sample space based on the plurality of scales for each member of the sample space, each scale including at least one test score.

21. The computer readable medium according to claim 20, wherein the set of instructions for generating a filter further comprises instructions for:
a. computerized ranking of the plurality of scales based on a criterion; and
b. assigning, from the among plurality of scales, the first group of scales, based on their associated rankings.

22. The computer readable medium according to claim 20, wherein the set of instructions for generating a filter further comprises instructions for calculating a t-test result for each of the plurality of scales.

23. The computer readable medium according to claim 22, wherein the set of instructions for generating a filter further comprises instructions for:
a. computerized ranking of the plurality of scales based on their associated t-test results; and
b. assigning, from among the plurality of scales, the first group of scales based on their associated t-test result rankings.

24. The computer readable medium according to claim 20, wherein the set of instructions for generating a filter further comprises instructions for evaluating the first group of scales based upon a user input.

25. The computer readable medium according to claim 20, wherein the set of instructions for generating a filter further comprises instructions for refining the first group of scales.

26. The computer readable medium according to claim 20, wherein the set of instructions for generating a filter further comprises instructions for assigning a scale to the first group of scales.

27. The computer readable medium according to claim 20, wherein the set of instructions for generating a filter comprises re-assigning a scale from the first group of scales to a second group of scales.

28. The computer readable medium according to claim 20, wherein the sample space comprises a first subject group and a second subject group, and further wherein the new subject is included in one of the first and second subject groups.

29. The computer readable medium according to claim 28, wherein the set of instructions for comparing further comprises instructions for:
a. randomly sampling the first subject group, thereby producing a plurality of sample sets; and
b. performing statistical analysis on each of the plurality of sample sets, thereby producing statistics of each of the plurality of sample sets from the first subject group.

30. The computer readable medium according to claim 29, wherein the set of instructions for comparing further comprises instructions for:
c. performing statistical analysis on the second subject group, thereby producing statistics of the second subject group; and
d. comparing the statistics of at least one of the plurality of sample sets of the first subject group with the statistics of the second subject group.

31. The computer readable medium according to claim 30, wherein the statistics further comprise one of mean, variance, standard deviation, range, maximum, minimum, sum, sum of squares, and any combination thereof.

32. The computer readable medium according to claim 20, further comprising a set of instructions for displaying the statistics on a display.

33. The computer readable medium according to claim 20, further comprising a set of instructions for importing test scores from a computer file.

34. The computer readable medium according to claim 20, wherein the test scores were obtained using a psychological test performed on the sample space.

35. A system for analyzing test scores obtained from a sample space based on a plurality of scales for each member of the sample space, wherein a preference is known regarding each member of the sample space, the system comprising:
a. a database for storing the test scores and the plurality of scales, each scale comprising at least one test score;
b. a computer operatively coupled to the database, wherein the computer is configured for:
(i) generating a filter including selecting a first group of scales from among the plurality of scales, which accommodates the preference; and
(ii) comparing a new subject against the first group of scales for conformance to the preference, and
c. a terminal operatively coupled to the computer, the terminal having a user interface, wherein the user interface is configured for receiving a user input evaluation of the first group of scales.

36. The system according to claim 35, wherein the computer is further configured for ranking the plurality of scales based on a criterion.

37. The system according to claim 36, wherein the computer is further configured for assigning, from among the plurality of scales, the first group of scales based on their associated rankings.

38. The system according to claim 35, wherein the computer is further configured for determining statistics for the sample space based on the first group of scales.

39. The system according to claim 36, wherein the criterion includes a t-test result of a scale.

40. The system according to claim 39, wherein the system further comprises a display for displaying the plurality of scales, the test scores, and the statistics.
